(19) United States
(12) Patent Application Publication
(10) Pub. No.: US 2020/0132991 A1
(43) Pub. Date: Apr. 30, 2020

(54) BACKLIGHT UNIT AND HEAD-UP DISPLAY DEVICE

(71) Applicant: Yazaki Corporation, Tokyo (JP)

(72) Inventor: Noriaki Narushima, Shizuoka (JP)

(21) Appl. No.: 16/588,579

(22) Filed: Sep. 30, 2019

(30) Foreign Application Priority Data
Oct. 26, 2018 (JP) 2018-201503

(51) Int. Cl. G02B 27/01; G02F 1/133; G02F 1/1335

(52) U.S. Cl. CPC G02B 27/01; G02F 1/13306; G02F 1/133615; G02F 1/133555; G02F 1/133603; G02F 1/133528

(57) ABSTRACT

A backlight unit includes a light source and a lens that has an incident surface facing the light source and an emission surface that is a surface on the opposite side to the incident surface and faces a liquid crystal display unit of a light transmission type, and has a shape of condensing light incident on the incident surface from the light source toward the liquid crystal display unit. The lens is configured with a transparent layer and a diffusion layer for diffusing light placed on top of each other between the incident surface and the emission surface. The diffusion layer covers an entire surface of the transparent layer on the liquid crystal display unit side.

### CROSS-REFERENCE TO RELATED APPLICATION(S)

The present application claims priority to and incorporates by reference the entire contents of Japanese Patent Application No. 2018-201503 filed in Japan on Oct. 26, 2018.

### BACKGROUND OF THE INVENTION

### 1. Field of the Invention

The present invention relates to a backlight unit and a head-up display device.

### 2. Description of the Related Art

There has been known a backlight unit which condenses light emitted from a light source by a condensing lens and then emits the light toward a liquid crystal display unit or the like. Such a backlight unit is used, for example, in a head-up display device.

Japanese Patent Application Laid-open No. 2009-122654 discloses a technique related to a display device including a light source unit in which a plurality of light sources are provided on a circuit board, a lens member in which a plurality of lenses for condensing illumination light from light sources are provided corresponding to the light sources, and a display element which is transmitted and illuminated by emission light emitted from each lens. In the lens member, a connecting portion for connecting a boundary portions between the lenses is formed.

According to the display device of Japanese Patent Application Laid-open No. 2009-122654, it is possible to minimize luminance unevenness of the illumination light passing through the display element.

In a backlight unit, the number of parts is desirably reduced.

### SUMMARY OF THE INVENTION

An object of the present invention is to provide a backlight unit in which the number of parts can be reduced.

In order to achieve the above mentioned object, a backlight unit according to one aspect of the present invention includes a light source; and a lens that includes an incident surface facing the light source and an emission surface that is a surface on an opposite side to the incident surface and faces a liquid crystal display unit of a light transmission type, and has a shape of condensing light incident on the incident surface from the light source toward the liquid crystal display unit, wherein the lens is configured with a transparent layer and a diffusion layer that diffuses light placed on top of each other between the incident surface and the emission surface, and the diffusion layer covers an entire surface of the transparent layer on the liquid crystal display unit side.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a head-up display device according to an embodiment;

FIG. 2 is a cross-sectional view illustrating a backlight unit according to the embodiment;

FIG. 3 is a plan view illustrating a lens array of the embodiment;

FIG. 4 is a cross-sectional view illustrating the backlight unit according to a modification of the embodiment; and

FIG. 5 is a cross-sectional view illustrating another backlight unit according to the modification of the embodiment.

### DETAILED DESCRIPTION OF THE PREFERRED EMBODIMENTS

Hereinafter, a backlight unit and a head-up display device according to an embodiment of the present invention will be described in detail with reference to the drawings. Note that the present invention is not limited by this embodiment. In addition, constituents in the embodiment described below include those that can be easily conceived by those skilled in the art or those that are substantially the same.

### EMBODIMENT

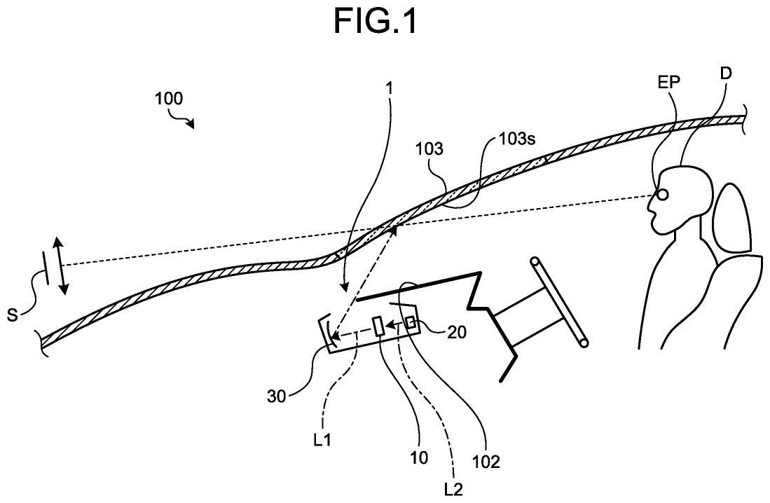

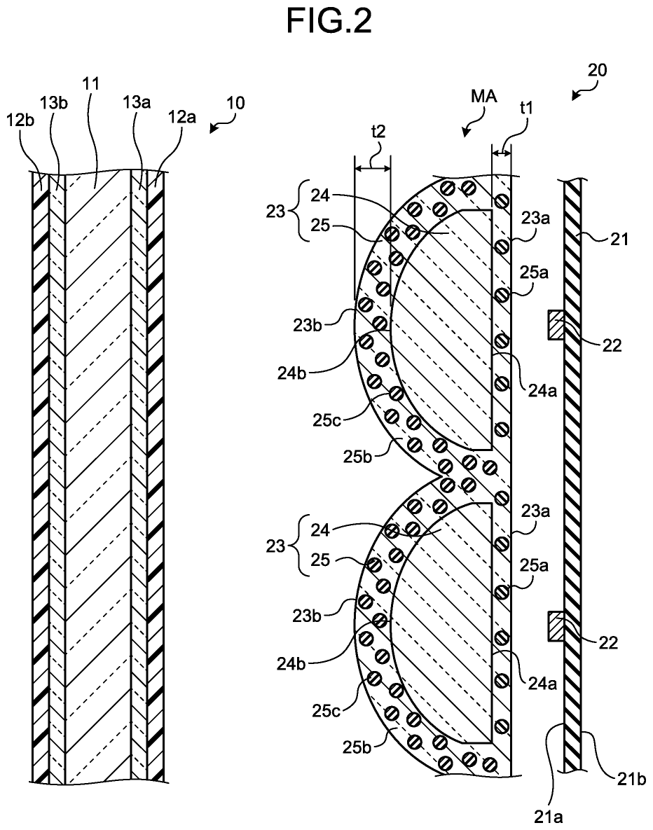

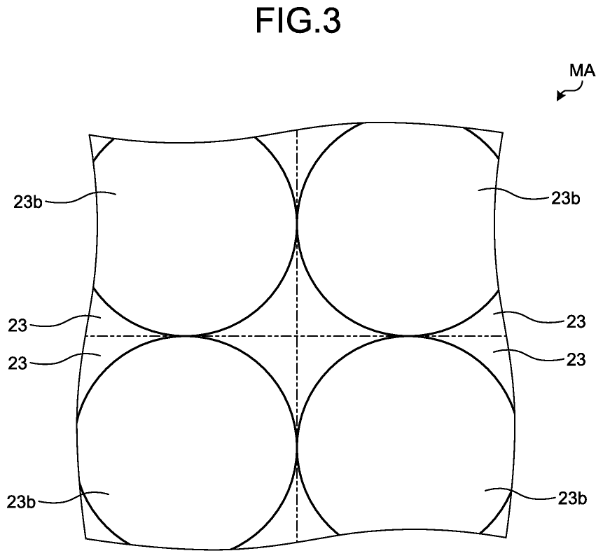

An embodiment will be described with reference to FIGS. 1 to 3. The embodiment relates to a backlight unit and a head-up display device. FIG. 1 is a schematic configuration diagram of the head-up display device according to the embodiment. FIG. 2 is a cross-sectional view illustrating the backlight unit according to the embodiment. FIG. 3 is a plan view illustrating a lens array of the embodiment. Note that FIG. 2 illustrates a cross section of the backlight unit and the liquid crystal display unit in a vertical direction of a vehicle. FIG. 3 is a plan view of the lens array of the embodiment as viewed from the liquid crystal display unit side.

As illustrated in FIG. 1, a head-up display device 1 according to the embodiment is mounted on a vehicle 100, such as an automobile. The head-up display device 1 is arranged inside a dashboard 102 of the vehicle 100. The head-up display device 1 projects display light L1 toward a reflective surface 103s of a display member 103 in the vehicle 100. In the embodiment, the display member 103 is a windshield. The display member 103 is disposed in front of a driver D in the vehicle 100. The reflective surface 103s of the display member 103 may be subjected to a semi-transmissive coating or the like that reflects part of incident light and transmits another part of the incident light. The display light L1 projected on the reflective surface 103s is reflected from the reflective surface 103s to an eye point EP of the vehicle 100, and is visually recognized as a virtual image S by the driver D.

The head-up display device 1 according to the embodiment includes a liquid crystal display unit 10, a backlight unit 20 according to the embodiment, and a reflection member 30. The liquid crystal display unit 10 is configured with a light transmission type thin film transistor liquid crystal display (TFT liquid crystal display) or the like. The liquid crystal display unit 10 displays a display image including a number, a character, a figure, and the like in accordance with a control signal from a control unit (not illustrated) mounted on the vehicle 100.

The backlight unit 20 is a lighting device that emits light L2 toward the liquid crystal display unit 10. As illustrated in FIG. 2, the backlight unit 20 includes a base 21, a light source 22, and a lens 23. The base 21 is a plate-like member having two main surfaces 21a and 21b. The light source 22 is fixed to one of the main surface 21a of the base 21. A light emitting diode (LED) can be used as the light source 22. The light source 22 is turned on when power is supplied from a power source mounted on the vehicle 100. A heat sink (not illustrated) may be fixed to the other main surface 21b of the base 21. Heat generated by the light source 22 is accumulated in the base 21. Here, the heat sink releases the heat accumulated in the base 21 to the outside of the backlight unit 20.

The lens 23 is a lens that condenses and diffuses the light emitted from the light source 22. The lens 23 has an incident surface 23a facing the light source 22 and an emission surface 23b which is a surface opposite to the incident surface 23a. When viewed from the liquid crystal display unit 10 side, the lens 23 according to the embodiment is formed in a shape in which the emission surface 23b having a hemispherical shape protrudes from a rectangular plate-like portion that constitutes the incident surface 23a (see FIG. 3). That is, the lens 23 is a plano-convex lens in which the incident surface 23a is a flat surface and the emission surface 23b is a convex curved surface.

As illustrated in FIG. 2, the lens 23 has a transparent layer 24 and a diffusion layer 25. The lens 23 is configured with the transparent layer 24 and the diffusion layer 25 placed on top of each other between the incident surface 23a and the emission surface 23b. The transparent layer 24 is a transparent layer that transmits light. Further, the diffusion layer 25 is a layer that diffuses light. A haze value of the diffusion layer 25 is higher than a haze value of the transparent layer 24. That is, the diffusion layer 25 is a layer having a light diffusion property higher than that of the transparent layer 24. The diffusion layer 25 covers at least an entire surface 24b of the transparent layer 24 on the liquid crystal display unit 10 side. That is, the diffusion layer 25 is in close contact with at least the entire surface 24b of the transparent layer 24 on the liquid crystal display unit 10 side. In the lens 23 of the embodiment, the transparent layer 24 is formed to be wrapped by the diffusion layer 25. That is, the entire surface of the transparent layer 24 is covered with the diffusion layer 25.

The transparent layer 24 of the embodiment has a shape of condensing light incident on the transparent layer 24 from the light source 22 side toward the liquid crystal display unit 10. A surface 24a of the transparent layer 24 on the incident surface 23a side is formed as a flat surface. Further, a surface 24b of the transparent layer 24 on the liquid crystal display unit 10 side is formed as a convex curved surface. The incident surface 23a and the emission surface 23b of the embodiment are configured with the diffusion layer 25. Here, the diffusion layer 25 is formed such that a thickness t1 of the diffusion layer 25 constituting the incident surface 23a is uniform. That is, the incident surface 23a of the diffusion layer 25 and the surface 24a of the transparent layer 24 on the light source 22 side are formed along each other. Further, the diffusion layer 25 is formed so that a thickness t2 of the diffusion layer 25 constituting the emission surface 23b is uniform. That is, the emission surface 23b of the diffusion layer 25 and the surface 24b of the transparent layer 24 on the liquid crystal display unit 10 side are formed along each other.

The thickness of the diffusion layer 25 is set so that the lens 23 can condense light emitted from the light source 22 toward the liquid crystal display unit 10, and the diffusion degree of the diffusion layer 25 is to an extent of enabling suppression of generation of color unevenness and luminance unevenness of the condensed light.

In the embodiment, the thickness t2 of an emission side portion 25b (the diffusion layer 25 constituting the emission surface 23b), which is a portion of the diffusion layer 25 closer to the liquid crystal display unit 10 with respect to the transparent layer 24, is formed to be larger than the thickness t1 of an incident side portion 25a (the diffusion layer 25 constituting the incident surface 23a), which is a portion of the diffusion layer 25 closer to the light source 22 with respect to the transparent layer 24. The thickness t1 of the incident side portion 25a and the thickness t2 of the emission side portion 25b are set so that the lens 23 can condense the light emitted from the light source 22 toward the liquid crystal display unit 10, and the diffusion degree is to an extent of enabling suppression of generation of color unevenness and luminance unevenness of the collected light.

The transparent layer 24 is formed of transparent resin, such as an acrylic resin. The diffusion layer 25 is formed using transparent resin, such as an acrylic resin, in which a light diffusion material 25c is dispersed. The light diffusion material 25c of the embodiment is a light diffusion bead. The light diffusion bead is a fine particle for light diffusion formed of a resin material having a refractive index different from that of the transparent resin used as the base material of the diffusion layer 25.

The lens 23 of the embodiment is integrally molded. The lens 23 is formed, for example, by filling a mold in which the transparent layer 24 is disposed with a resin material (a resin material to be the diffusion layer 25) in which the light diffusion material 25c is dispersed.

In the embodiment, a plurality of the light sources 22 and the lenses 23 are provided. A plurality of the light sources 22 are arranged in a matrix on the main surface 21a of the base 21. As illustrated in FIG. 3, a plurality of the lenses 23 constitute one lens array MA. As illustrated in FIG. 2, a plurality of the lenses 23 are arranged such that one of the lenses 23 corresponds to one of the light sources 22 on a one-to-one basis. That is, a plurality of the lenses 23 are arranged in a matrix along the main surface 21a, and the incident surface 23a of one of the lenses 23 is disposed to face one of the light sources 22. A plurality of the lenses 23 are connected to one another via the diffusion layer 25 covering a side surface of the transparent layer 24. The lens array MA of the embodiment is molded, for example, by disposing a plurality of the transparent layers 24 connected via a rod-like frame in a mold, filling the mold with a resin material to be the diffusion layer 25 and, after that, removing the rod-like frame.

The liquid crystal display unit 10 according to the embodiment includes a liquid crystal layer 11, a pair of polarizing plates 12a and 12b, and a pair of substrates 13a and 13b. The liquid crystal layer 11 is disposed between a pair of the polarizing plates 12a and 12b. The substrate 13a is disposed between the liquid crystal layer 11 and the polarizing plate 12a, and the substrate 13b is disposed between the liquid crystal layer 11 and the polarizing plate 12b. A pair of counter electrodes is provided on a pair of the substrates 13a and 13b. A pair of the counter electrodes is configured with a plurality of pixel electrodes and a common electrode. The pixel electrodes are provided on the substrate 13a as electrodes each corresponding to one pixel. The common electrode is provided on the substrate 13b as a common electrode of a plurality of the pixel electrodes. The crystal orientation of the liquid crystal layer 11 changes in accordance with a potential difference generated between a pair of the counter electrodes. A pair of the polarizing plates 12a and 12b is disposed in a cross-nicol relationship, and the light transmittance of the liquid crystal display unit 10 is controlled in accordance with a change in the crystal orientation of the liquid crystal layer 11.

In the backlight unit 20, the light emitted from the light source 22 is diffused while being condensed by the lens 23, and is emitted as the light L2 from the emission surface 23b toward the liquid crystal display unit 10. The liquid crystal display unit 10 projects at least part of the light L2 as the display light L1 corresponding to the display image by controlling the potential difference between the counter electrodes for each of the pixel electrodes to transmit at least a part of the light L2.

As illustrated in FIG. 1, the display light L1 projected from the liquid crystal display unit 10 is reflected by the reflection member 30 to the reflective surface 103s facing the eye point EP. The reflection member 30 is a magnifying mirror that magnifies and reflects the display light L1 projected from the liquid crystal display unit 10. For example, an aspherical mirror can be used as the reflection member 30.

As described above, the backlight unit 20 according to the embodiment includes the light source 22 and the lens 23 that has the incident surface 23a facing the light source 22 and the emission surface 23b that is a surface on the opposite side to the incident surface 23a and faces the liquid crystal display unit 10 of a light transmission type, and has a shape of condensing light incident on the incident surface 23a from the light source 22 toward the liquid crystal display unit 10. The lens 23 is configured with the transparent layer 24 and the diffusion layer 25 for diffusing light placed on top of each other between the incident surface 23a and the emission surface 23b. The diffusion layer 25 covers the entire surface 24b of the transparent layer 24 on the liquid crystal display unit 10 side.

In the backlight unit 20 according to the embodiment, the lens 23 has a function of condensing the light emitted from the light source 22 toward the liquid crystal display unit 10 and a function of diffusing the light emitted from the lens 23. As a configuration different from the embodiment, a configuration of a backlight unit that includes a condensing lens for condensing light from a light source, and a diffusion plate that is provided as a separate member from the condensing lens and diffuses light emitted from the condensing lens is also conceivable. Here, the diffusion plate is a member that diffuses light (for example, parallel light) that is condensed by the condensing lens and emitted toward the liquid crystal display unit. The light condensed by the condensing lens is diffused by the diffusion plate, so that the range in which the display light can be visually recognized in the vehicle can be expanded. In contrast to the configuration different from the embodiment, in the configuration of the embodiment, the lens 23 has both the function of condensing light and the function of diffusing light. Therefore, the number of the diffusion plates can be reduced. That is, in the backlight unit 20 of the embodiment, the number of parts of the backlight unit can be reduced. Further, by reducing the number of parts, the weight of the backlight unit can be reduced.

Further, the lens 23 is configured with the transparent layer 24 and the diffusion layer 25 for diffusing light placed on top of each other between the incident surface 23a and an emission surface 23b, and the diffusion layer 25 covers the entire surface 24b of the transparent layer 24 on the liquid crystal display unit 10 side. The light from the light source 22 is diffused by the diffusion layer 25 and emitted from the emission surface 23b while being condensed by the lens 23. Since the light emitted from the emission surface 23b is diffused by the diffusion layer 25, it is possible to suppress, for example, color unevenness and luminance unevenness of light resulting from chromatic aberration of the lens.

In the backlight unit 20 according to the embodiment, the transparent layer 24 and the diffusion layer 25 are integrally molded. For example, in a case of molding a transparent lens (a lens formed of only a transparent layer) having the same size and shape as the lens 23, the mold is filled with a resin material, and then cooled. On the other hand, in the lens 23 of the embodiment, first, a mold corresponding to an outer shape of the transparent layer 24 is filled with a resin material to be the transparent layer 24 and cooled, so that the transparent layer 24 is molded. After the above, the transparent layer 24 is disposed in a mold corresponding to an outer shape of the diffusion layer 25 and the mold is filled with a resin material to be the diffusion layer 25 and cooled, so that the lens 23 is molded. That is, in the molding of the lens 23 of the embodiment, a process of cooling the resin material is performed in two different processes. In the processing time (tact time) of the lens using the mold, the time ratio occupied by the process of cooling the resin material in the mold is large compared to other processes, and sometimes occupies more than half the processing time of the lens. Here, the cooling time of the resin material increases as the thickness of the lens increases. In the embodiment, by dividing the cooling process into two processes, the volume of the resin material to be cooled in one cooling process can be reduced. Therefore, the cooling time of the resin material can be shortened. By shortening the cooling time, for example, the processing time for molding the lens 23 can be reduced.

Further, in the backlight unit 20 according to the embodiment, the emission surface 23b is configured with the diffusion layer 25. Since the emission surface 23b is configured with the diffusion layer 25, the light emitted from the lens 23 is emitted from the emission surface 23b in a diffused state. Accordingly, color unevenness and luminance unevenness caused by the chromatic aberration of the lens can be effectively suppressed.

Further, in the backlight unit 20 according to the embodiment, the thickness t2 of the diffusion layer 25 constituting the emission surface 23b is uniform. With this configuration, light incident on the diffusion layer 25 from the surface 24b of the transparent layer 24 on the liquid crystal display unit 10 side is uniformly diffused by the diffusion layer 25 and emitted from the emission surface 23b. Therefore, the bias of the diffusion degree of the light emitted from the emission surface 23b can be suppressed and, for example, the luminance unevenness of the light emitted from the emission surface 23b toward the liquid crystal display unit 10 can be suppressed. With this configuration, for example, the display quality of the display image can be improved.

Further, in the backlight unit 20 according to the embodiment, the incident surface 23a is configured with the diffusion layer 25. In the lens 23, by configuring the incident surface 23a with the diffusion layer 25, for example, the thickness of the diffusion layer 25 (the emission side portion 25b) constituting the emission surface 23b can be reduced by the thickness of the diffusion layer 25 (the incident side portion 25a) constituting the incident surface 23a.

Further, in the backlight unit 20 according to the embodiment, the thickness t1 of the diffusion layer 25 constituting the incident surface 23a is uniform. With this configuration, light emitted from the light source 22 and incident on the incident surface 23a is uniformly diffused by the diffusion layer 25 and is incident on the transparent layer 24. Therefore, it is possible to suppress the bias of the diffusion degree of the light emitted from the lens 23 toward the liquid crystal display unit 10. With this configuration, for example, the display quality of the display image can be improved.

Further, in the backlight unit 20 according to the embodiment, the shape of the transparent layer 24 is a shape for condensing light incident on the transparent layer 24 from the light source 22 side toward the liquid crystal display unit 10. With this shape, the light incident on the incident surface 23a from the light source 22 can be condensed by the transparent layer 24.

The head-up display device 1 according to the embodiment includes the liquid crystal display unit 10 of a light transmission type and the backlight unit 20. The backlight unit 20 includes the light source 22 and the lens 23 that has the incident surface 23a facing the light source 22 and the emission surface 23b that is a surface on the opposite side to the incident surface 23a and faces the liquid crystal display unit 10, and has a shape of condensing light incident on the incident surface 23a from the light source 22 toward the liquid crystal display unit 10. The lens 23 is configured with the transparent layer 24 and the diffusion layer 25 for diffusing light placed on top of each other between the incident surface 23a and the emission surface 23b. The diffusion layer 25 covers the entire surface 24b of the transparent layer 24 on the liquid crystal display unit 10 side.

In the head-up display device 1 according to the embodiment, the lens 23 has a function of condensing the light emitted from the light source 22 toward the liquid crystal display unit 10 and a function of diffusing the light emitted from the lens 23. Since light can be diffused while being condensed by one member, for example, the number of parts can be reduced. Further, since the light emitted from the emission surface 23b of the lens 23 is diffused by the diffusion layer 25 and emitted, it is possible to suppress, for example, color unevenness and luminance unevenness of emission light resulting from chromatic aberration of the lens.

Note that, in the above embodiment, the lens 23 is described as a plano-convex lens. However, the shape of the lens 23 is not limited to the above. The shape of the lens 23 may be any shape as long as the shape allows condensing of light incident on the incident surface 23a from the light source 22 toward the liquid crystal display unit 10, and may be, for example, a biconvex lens shape or a positive meniscus lens shape. Further, in the above-mentioned embodiment, although the shape of the emission surface 23b of the lens 23 as viewed from the liquid crystal display unit 10 side is described to be a hemispherical shape, the shape is not limited to the above. For example, the emission surface 23b of the lens 23 may be formed in a rectangular shape as viewed from the liquid crystal display unit 10 side.

Further, in the above embodiment, description is made by using an example where a plurality of the lenses 23 are disposed such that one of the lenses 23 corresponds to one of the light sources 22 on a one-to-one basis. However, the lenses 23 do not need to be disposed to correspond to the light sources 22 on a one-to-one basis. For example, one of the lenses 23 may be disposed to correspond to two or more of the light sources 22.

Further, in the above-mentioned embodiment, description is made by using an example where the lens 23 is configured with two layers, the transparent layer 24 and the diffusion layer 25. However, the configuration of the lens 23 is not limited to the above. For example, the lens 23 may include another resin layer that transmits light. For example, another transparent layer may be further provided on a surface of the diffusion layer 25 on the liquid crystal display unit 10 side. In this configuration, the transparent layer on the liquid crystal display unit 10 side with respect to the diffusion layer 25 constitutes the emission surface 23b. In this case, the emission surface 23b is provided in a shape along a curved surface of the diffusion layer 25 on the liquid crystal display unit 10 side.

### Modification of Embodiment

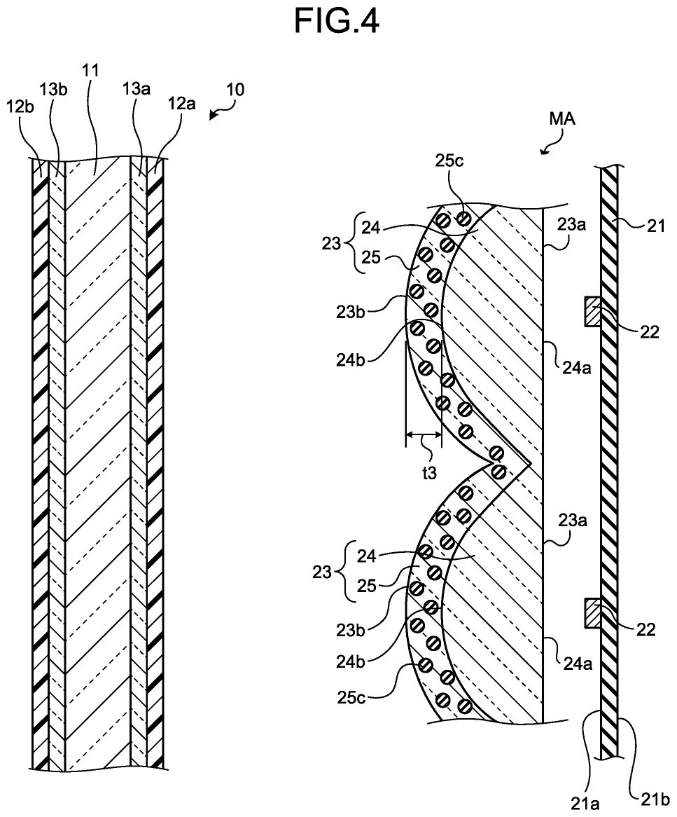

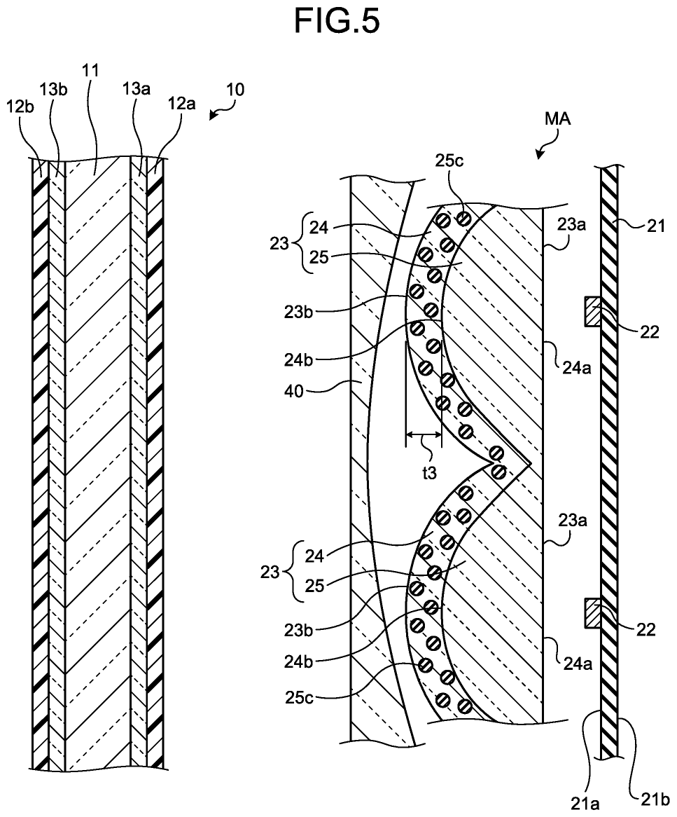

A modification of the embodiment will be described with reference to FIGS. 4 and 5. The modification of the embodiment relates to a head-up display device and a backlight unit. FIG. 4 is a cross-sectional view illustrating the backlight unit according to the modification of the embodiment. FIG. 5 is a cross-sectional view illustrating another backlight unit according to the modification of the embodiment. FIGS. 4 and 5 are cross-sectional views corresponding to FIG. 2 of the embodiment described above.

The backlight unit 20 according to the modification is different from the backlight unit 20 according to the above-described embodiment in that the incident surface 23a of the lens 23 is configured with the transparent layer 24 as illustrated in FIG. 4. Further, the lens 23 of the modification constitutes the lens array MA as in the above-described embodiment. Here, the lens array MA of the modification differs from the lens array MA according to the above-described embodiment in that the transparent layers 24 of the lenses 23 are connected to each other to form one of the lens array MA. The other configurations are the same as those of the above-described embodiment. Further, the head-up display device 1 according to the modification differs from the head-up display device 1 according to the above-described embodiment in that the backlight unit 20 according to the modification is included. The other configurations of the head-up display device 1 according to the modification are similar to those of the head-up display device 1 according to the above-described embodiment.

The lens 23 of the modification is molded in a manner that, for example, after the transparent layer 24 is molded with a mold as in the above-described embodiment, the transparent layer 24 is disposed in another mold corresponding to the lens 23 and the mold is filled with a resin material to be the diffusion layer 25 and cooled.

In the lens 23 of the modification, a cross-sectional shape of the diffusion layer 25 in a vertical direction of a vehicle is C-shaped, and covers the entire surface 24b of the transparent layer 24 on the liquid crystal display unit 10 side with a uniform thickness t3. In the lens array MA, the diffusion layers 25 of the lenses 23 are connected to each other to cover the entire surface 24b of the lens array MA on the liquid crystal display unit 10 side.

As described above, in the backlight unit 20 according to the modification, the incident surface 23a of the lens 23 is configured with the transparent layer 24.

Note that the lens 23 of the modification can also be formed, for example, by applying a resin material to be the diffusion layer 25 on the entire surface 24b of the transparent layer 24 on the liquid crystal display unit 10 side. Therefore, the diffusion layer 25 can also be formed without using a mold when the diffusion layer 25 is formed.

Note that the backlight unit 20 according to the modification may be configured by including a field lens 40, as illustrated in FIG. 5. The field lens 40 is formed of transparent resin and transmits light. The field lens 40 is disposed between the lens 23 and the liquid crystal display unit 10. The field lens 40 of the embodiment has one concave curved surface on the lens 23 (lens array MA) side, and has a flat surface on the liquid crystal display unit 10 side. That is, the field lens 40 of the embodiment is a plano-concave lens.

The field lens 40 functions to bring an eye box in the vehicle 100 and the emission surface 23b of the lens 23 into an optical conjugate relationship. Further, the field lens 40 refracts light emitted from the emission surface 23b so that the liquid crystal display unit 10 can be efficiently irradiated. Here, the eye box is an area including the eye point EP and assumed in advance as a space area, in which a driver D can visually recognize a display image while driving in a state of sitting in the driver's seat.

Note that the field lens 40 may have any shape as long as it can exhibit the above-described function, and may have a shape other than the shape of a plano-concave lens. For example, the shape of the field lens 40 may be a plano-convex lens shape, a biconvex lens shape, or a positive meniscus lens shape.

The content disclosed in the above-described embodiment and each modification can be implemented in combination as appropriate.

The backlight unit according to the present embodiment includes a lens having a shape for condensing light incident on an incident surface from a light source toward a liquid crystal display unit. The lens is configured with a transparent layer and a diffusion layer for diffusing light placed on top of each other between the incident surface and an emission surface, and the diffusion layer covers an entire surface of the transparent layer on the liquid crystal display unit side. In the backlight unit according to the present embodiment, light incident from the light source to the incident surface is diffused by the diffusion layer and emitted from the emission surface while being condensed by the lens having a shape for condensing light. According to the backlight unit according to the present embodiment, the function of condensing the light and the function of diffusing the light coexist in the lens, so that the number of parts can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A backlight unit comprising:
a light source; and
a lens that includes an incident surface facing the light source and an emission surface that is a surface on an opposite side to the incident surface and faces a liquid crystal display unit of a light transmission type, and has a shape of condensing light incident on the incident surface from the light source toward the liquid crystal display unit, wherein
the lens is configured with a transparent layer and a diffusion layer that diffuses light placed on top of each other between the incident surface and the emission surface, and
the diffusion layer covers an entire surface of the transparent layer on the liquid crystal display unit side.

2. The backlight unit according to claim 1, wherein
the transparent layer and the diffusion layer are integrally molded.

3. The backlight unit according to claim 1, wherein
the emission surface is configured with the diffusion layer.

4. The backlight unit according to claim 2, wherein
the emission surface is configured with the diffusion layer.

5. The backlight unit according to claim 3, wherein
a thickness of the diffusion layer constituting the emission surface is uniform.

6. The backlight unit according to claim 4, wherein
a thickness of the diffusion layer constituting the emission surface is uniform.

7. The backlight unit according to claim 1, wherein
the incident surface is configured with the diffusion layer.

8. The backlight unit according to claim 2, wherein
the incident surface is configured with the diffusion layer.

9. The backlight unit according to claim 3, wherein
the incident surface is configured with the diffusion layer.

10. The backlight unit according to claim 5, wherein
the incident surface is configured with the diffusion layer.

11. The backlight unit according to claim 7, wherein
a thickness of the diffusion layer constituting the incident surface is uniform.

12. The backlight unit according to claim 1, wherein
the incident surface is configured with the transparent layer.

13. The backlight unit according to claim 2, wherein
the incident surface is configured with the transparent layer.

14. The backlight unit according to claim 3, wherein
the incident surface is configured with the transparent layer.

15. The backlight unit according to claim 5, wherein
the incident surface is configured with the transparent layer.

16. The backlight unit according to claim 1, wherein
a shape of the transparent layer is a shape for condensing light incident on the transparent layer from the light source side toward the liquid crystal display unit.

17. The backlight unit according to claim 2, wherein
a shape of the transparent layer is a shape for condensing light incident on the transparent layer from the light source side toward the liquid crystal display unit.

18. The backlight unit according to claim 3, wherein
a shape of the transparent layer is a shape for condensing light incident on the transparent layer from the light source side toward the liquid crystal display unit.

19. The backlight unit according to claim 5, wherein
a shape of the transparent layer is a shape for condensing light incident on the transparent layer from the light source side toward the liquid crystal display unit.

20. A head-up display device comprising:
a liquid crystal display unit of a light transmission type; and
a backlight unit, wherein
the backlight unit includes
a light source, and
a lens that includes an incident surface facing the light source and an emission surface that is a surface on an opposite side to the incident surface and faces the liquid crystal display unit, and has a shape of condensing light incident on the incident surface from the light source toward the liquid crystal display unit,
the lens is configured with a transparent layer and a diffusion layer that diffuses light placed on top of each other between the incident surface and the emission surface, and
the diffusion layer covers an entire surface of the transparent layer on the liquid crystal display unit side.
